(19) United States
(12) Patent Application Publication
(10) Pub. No.: US 2021/0308494 A1
(43) Pub. Date: Oct. 7, 2021

(54) PERSONAL SAFE BREATHING DEVICE

(71) Applicants: Chris Salvino, SCOTTSDALE, AZ (US); Kenneth Altshuler, Longmont, CO (US)

(72) Inventors: Chris Salvino, SCOTTSDALE, AZ (US); Kenneth Altshuler, Longmont, CO (US)

(21) Appl. No.: 17/219,396

(22) Filed: Mar. 31, 2021

Related U.S. Application Data
(60) Provisional application No. 63/003,880, filed on Apr. 1, 2020.

(51) Int. Cl. A62B 7/12; A62B 9/02; A62B 7/10; B64D 11/00; A42C 5/04

(52) U.S. Cl. CPC A62B 7/12; A62B 9/02; B64D 2231/025; B64D 11/00; A42C 5/04; A62B 7/10

(57) ABSTRACT

Described are concepts that generally relate to a personal positive pressure purified air environment for airplane travel. Simply put, certain embodiments of the present invention are directed to connecting a tube to an airplane air vent at one end and a clear plastic hood, mask, or helmet at the other end. The clear plastic hood, mask, or helmet all have an exit path for the air to flow out. In relation to the clear plastic hood embodiment, it is envisioned that the clear plastic hood can simply drape over person's head with the hood's opening at or above a person shoulder while positive pressure from the filtered air constantly flows out from the hood's opening.

### CROSS-REFERENCE TO RELATED APPLICATIONS

This application is a non-provisional application claiming priority to and the benefit of U.S. Provisional Patent Application Ser. No. 63/003,880, entitled Personal Safe Breathing Device filed Apr. 1, 2020, the entire disclosure of which is hereby incorporated by reference.

### FIELD OF THE INVENTION

The present embodiments are directed to a personal purified air environment that covers a person's head.

### DESCRIPTION OF RELATED ART

One of the major concerns when traveling in an airplane is exposure to viruses and bacteria from adjacent passengers. Though most passenger airplanes provide filtered air by way of adjustable air vents located above the rows of passenger seating, passengers still get sick. Accordingly, most passengers either wear facemasks in an attempt to filter out germs or simply hope for the best.

FIG. 1A shows a photograph of individual adjustable air vents 120 in a standard overhead passenger service unit 150, located above passenger seats (not shown). For reference, overhead passenger service units 150 are typically located on the underside of the bottom shelf use for overhead carry-on baggage. Each of the three air vents 120 direct a pressurized stream of filtered air to a corresponding passenger location at one of three seats in a row of seats. In this particular arrangement, the adjustable air vents 120 can be twisted in one direction to open and the other direction to close and can further be swiveled to direct air over a passenger or in a manner that suits the passenger 101, FIG. 1B. The adjustable air vents 120 are typically smooth and are not configured to connect with anything, they simply exist to direct a stream of filtered air through the cabin environment 210 towards the sitting passenger.

FIG. 1B illustratively depicts a line drawing of a passenger 101 sitting under an air vent 120. As is shown, the air vent 120 directs a stream of filtered air 125 at the passenger's head 100. Because the stream of filtered air 125 is filtered by a central onboard filter system, typically a High-Efficiency Particle Filter (HEPA), passengers are encouraged to point the filtered air at their face, i.e., their eyes 110, nose 108 and mouth 106. Some airlines promote that HEPA filters filter over 99% of microbes on a plane. Even with these measures, most people experience catching respiratory illnesses, stomach bugs and other forms of illness directly on airplanes making it an unsavory environment for many.

It is to innovations related to this subject matter that the claimed invention is generally directed.

### SUMMARY OF THE INVENTION

The present embodiments are directed to a personal positive pressure purified air environment for airplane travel and/or personal use in a non-travel environment or application.

Some embodiments of the present invention contemplate a protective airplane hood arrangement comprising a hood defining a hood interior having an upper half and a lower half and further defining a hood crown that is configured to interface a human head apex. The hood is sized to cover a person's head and terminating in a hood exit rim/opening that is between a person's chin and their shoulders. A tube extends between a proximal end and a distal end wherein the distal end comprises an overhead airplane ventilation nozzle coupling (coupling). The proximal end in communication with the hood interior wherein the hood interior in communication with the coupling. The coupling is configured to connect to an overhead airplane ventilation nozzle. The tube is configured to channel air from the overhead airplane ventilation nozzle and into the hood interior within 4 inches vertically from the hood crown.

Yet another embodiment of the present invention contemplates a hood arrangement comprising a hood defining a hood interior, a hood crown and a hood exit rim. The hood exit rim is configured to pull over a person's head until the hood cover's the person's head. A hollow tube extends from the hood and attaches to an overhead airplane ventilation nozzle at a distal tube end of the tube via an overhead airplane ventilation nozzle coupling (coupling). Pressurized air that is dispensed from the overhead airplane ventilation nozzle flows from a proximal end of the hollow tube towards and through the hood exit rim.

Still other certain embodiments of the present invention contemplate an airplane filtered air hood system comprising a hood configured to cover a person's head. The hood system further including a hollow tube that extends from the hood to be connected to an overhead airplane ventilation nozzle via an overhead airplane ventilation nozzle coupling. A hood interior of the hood is in communication with the overhead airplane ventilation nozzle via the hollow tube. A hood exit rim receives channeled filtered air from inside of the hood wherein the filtered air is exclusively provided by the overhead airplane ventilation nozzle via the hollow tube.

### BRIEF DESCRIPTION OF THE DRAWINGS

FIG. 1A shows a photograph of individual adjustable air vents in a standard overhead passenger service unit 150, located above passenger seats;

FIG. 1B illustratively depicts a line drawing of a passenger sitting under an air vent;

FIG. 2 illustratively depicts a line drawing of a shoulder length hood and vent tube embodiment consistent with embodiments of the present invention;

FIG. 3 illustratively depicts a line drawing of a neck length hood and vent tube embodiment consistent with embodiments of the present invention;

FIG. 4 illustratively depicts a line drawing embodiment of a shoulder length hood and vent tube configured with a hat consistent with embodiments of the present invention;

FIG. 5 illustratively depicts a line drawing embodiment of a helmet connected to an airplane vent consistent with embodiments of the present invention;

FIGS. 6A and 6B illustratively depict line drawings of a facemask embodiment consistent with embodiments of the present invention;

FIGS. 7A and 7B illustratively depict a valve system used with a positive pressure filtered air environment consistent with embodiments of the present invention;

FIG. 8A it is a line drawing of two passengers sitting on an airplane with the hood 200 consistent with embodiments of the present invention;

FIG. 8B is a line drawing of a woman wearing the hood and hat combination in an environment other than the airplane consistent with embodiments of the present invention;

FIG. 9A illustratively depicts a line drawing of a profile of a human head wearing a hat and hood combination consistent with embodiments of the present invention;

FIG. 9B illustratively shows an alternative embodiment of a hat and hood combination consistent with embodiments of the present invention;

FIG. 9C is a line drawing of a person wearing an optional hat embodiment consistent with embodiments of the present invention;

FIG. 10 illustratively depicts yet another embodiment of an air delivery system consistent with embodiments of the present invention;

FIG. 11A illustratively depicts an optional hat and hood combination 820 consistent with embodiments of the present invention;

FIG. 11B is a line drawing depicting another embodiment of a hat and hood combination consistent with embodiments of the present invention;

FIG. 11C as a line drawing showing yet another embodiment of a hat and hood combination consistent with embodiments of the present invention;

FIG. 11D as a line drawing showing a different embodiment of a hat and hood combination consistent with embodiments of the present invention;

FIG. 11E illustratively depicts a line drawing of yet a different embodiment of a hat and hood combination consistent with embodiments of the present invention;

FIG. 11F is a line drawing that illustratively depicts a person wearing yet a different embodiment of a hat and hood combination consistent with embodiments of the present invention;

FIG. 11G is a line drawing that illustratively depicts a person wearing yet another embodiment of a hat hood combination consistent with embodiments of the present invention;

FIG. 12 is a line drawing of a back view of a standing person wearing a hat and hood combination with a filter system consistent with embodiments of the present invention; and

FIGS. 13A and 13B show an example of a universal connector system consistent with embodiments of the present invention.

### DETAILED DESCRIPTION

Initially, this disclosure is by way of example only, not by limitation. Thus, although the instrumentalities described herein are for the convenience of explanation, shown and described with respect to exemplary embodiments, it will be appreciated that the principles herein may be applied equally in other similar configurations involving similar uses of a personal positive pressure purified air environment apparatus. The phrases “in one embodiment”, “according to one embodiment”, and the like generally mean the particular feature, structure, or characteristic following the phrase is included in at least one embodiment of the present invention, and may be included in more than one embodiment of the present invention. Importantly, such phases do not necessarily refer to the same embodiment. If the specification states a component or feature “may”, “can”, “could”, or “might” be included or have a characteristic, that particular component or feature is not required to be included or have the characteristic. As used herein, the terms “having”, “have”, “including” and “include” are considered open language and are synonymous with the term “comprising”. In what follows, similar or identical structures may be identified using identical callouts.

Certain embodiments of the present invention generally relate to a personal positive pressure purified air environment for airplane travel. Simply put, certain embodiments of the present invention are directed to connecting a tube to an airplane air vent 120 at one end and a clear plastic hood, mask, or helmet at the other end. The clear plastic hood, mask, or helmet all have an exit path for the air to flow out. In relation to the clear plastic hood embodiment, it is envisioned that the clear plastic hood can simply drape over person's head with the hood's opening at or above a person shoulder while positive pressure from the filtered air constantly flows out from the hood's opening.

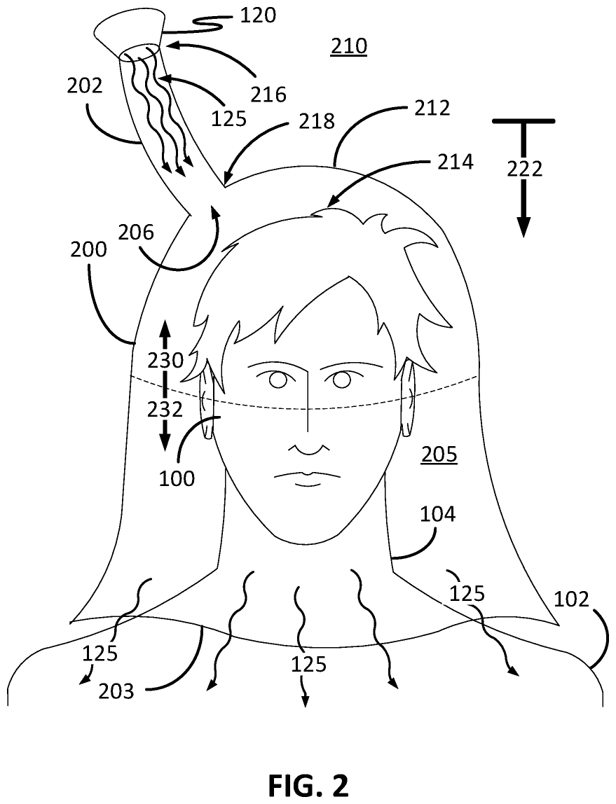

FIG. 2 is a line drawing illustratively depicting a shoulder length hood and vent tube embodiment in use consistent with embodiments of the present invention. As shown, a shoulder length clear plastic hood 200 is covering a passenger's head 100 down to their shoulders 102. As positive pressure air 125 flows from the air vent 120, into the tube 202 via the tube's distal opening/end 216, and into the hood 200 through an intake opening/aperture 206 near or at the top of the clear plastic hood 200. The inner hood environment 205 provides essentially purified air that positively flows 125 out from the hood's opening 203 at the bottom of the clear plastic hood 200. Because the filtered air 125 inside of the clear plastic hood 200 is flowing through the hood 200 and out of the bottom opening 203, bacteria and viruses that are otherwise in the main airplane cabin's environment 210 will flow away from the bottom opening 203. In this way, the passenger 101 is protected from germ exposure to their eyes 110, nose 108 and mouth 106 that may be present in the outside environment 210. The clear plastic hood 200 can include an antibacterial and/or antiviral coding on either the inside of the hood 200, the outside of the hood 200 or both. Certain embodiments contemplate the hood opening 203 having a wire rim, or armature, to keep the hood 200 from collapsing around the passenger's neck 104 or body. Certain embodiments envision the hood 200 being a thin flexible hood (between 0.5-2 um thick), such as a clear plastic bag use for dry-cleaning, that a person can effortlessly see through and communicate to others while wearing. Other certain embodiments envision the bottom opening 203 being large enough for a person to easily pull the hood 200 over their face 105 to eat, drink, or otherwise access their face 105, such as to apply an emergency air mask in time of need without difficulty. For purposes of convention, the upper half of the hood 230 covers the person's head apex 214, eyes 110 and at least part of their nose 108. The top of the hood 200 defines a hood crown 212 that covers the person's head apex 214 when worn. Certain embodiments envision the tube 202 feeding the pressurized filtered air 125 inside 205 of the hood 200 within 4 inches vertically 222 from the hood crown 212. In this embodiment, the tube's proximal end 218 is attached to the hood 200 at a hood aperture 220.

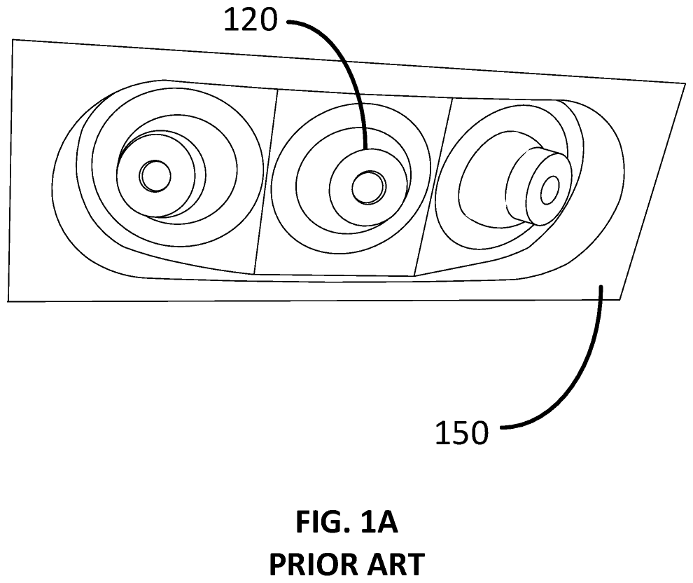

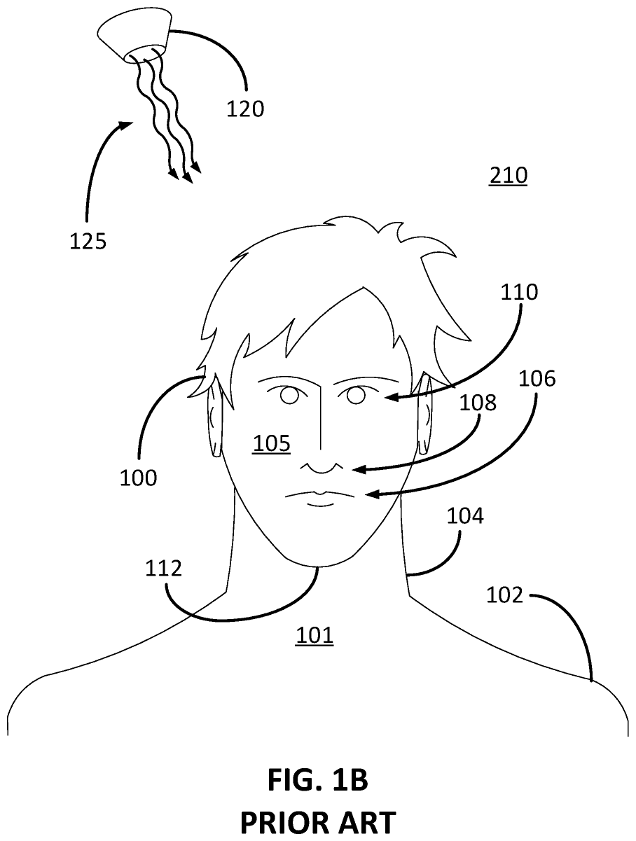

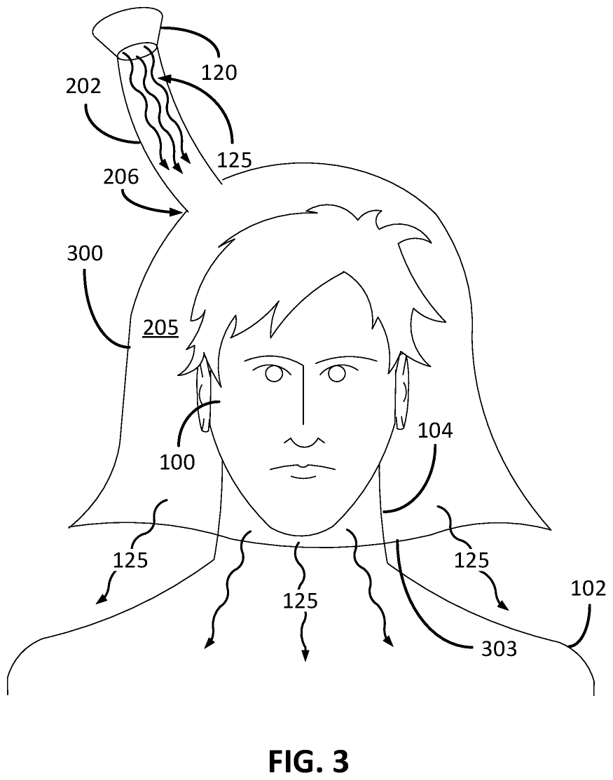

FIG. 3 illustratively depicts a simple line drawing of a neck length hood and vent tube embodiment consistent with embodiments of the present invention. As shown, a neck length clear plastic hood 300 is covering a passenger's head 100 just below their chin 112 (see FIG. 1B). Again, a flexible tube 202 is attached to an airplane filtered air vent 120 thereby receiving filtered pressurized air 125 that flows through the flexible tube 202 and into the clear plastic hood 300 and out through the bottom opening 303. Even though the clear plastic hood 300 only goes to the passenger's neck 104 just below their chin 112, the inner hood environment 205 will maintain positive pressure, just like in a clean room, thereby protecting the passenger 101 from germs floating around the main cabin. Certain embodiments envision an anti-bacterial coating on the outside, the inside or both of the head covering 300 (or other coverings).

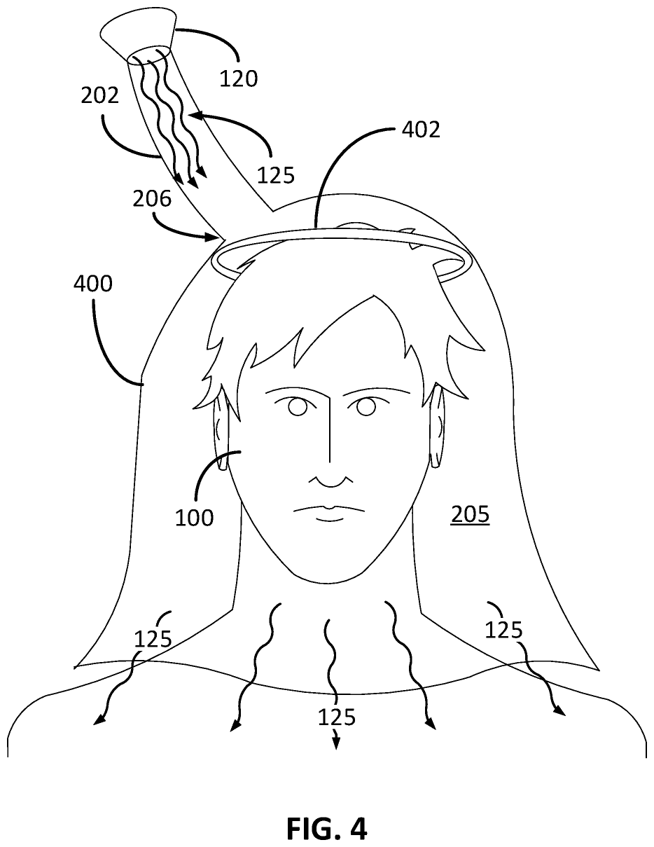

FIG. 4 illustratively depicts a simple line drawing embodiment of a shoulder length hood and vent tube configured with a hat consistent with embodiments of the present invention. As shown, a shoulder length hood 400 is built in with a hat 402 that conforms to the top of a passenger's head 100. The hat could be a simple rim 402 as shown, or could be a baseball cap, or some other kind of hat with the hood 400 draped over the passengers head 100. So long as the clear plastic hood 400 can maintain positive pressure 125 from the air vent 120 and flexible tube 202 assembly to ensure a clean inner environment 205 free of germs from the main cabin. It should be appreciated that other length hoods can equally be used without departing from the scope and spirit of the present embodiment.

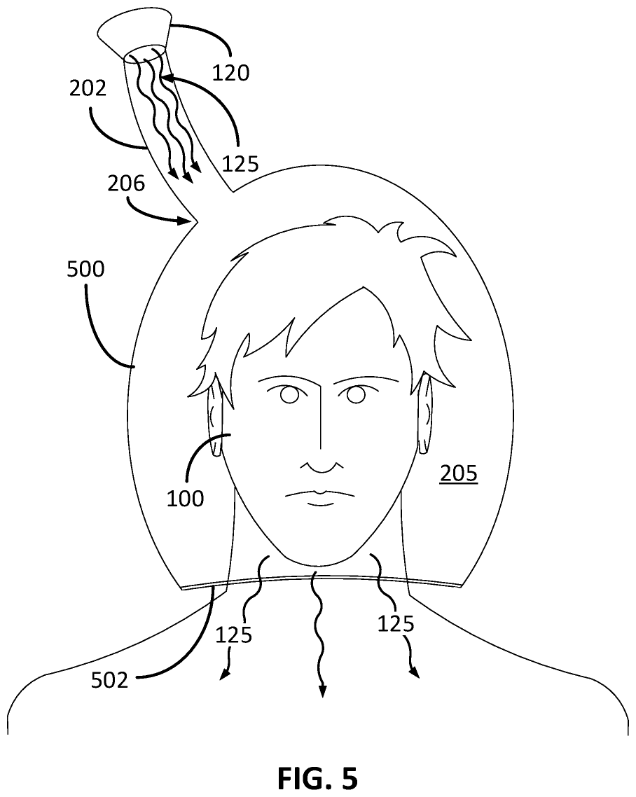

FIG. 5 illustratively depicts a simple line drawing embodiment of a helmet connected to an airplane vent consistent with embodiments of the present invention. Here, a clear rigid helmet 500 is placed over a passenger's head 100. The clear rigid helmet 500 is connected to a the air vent 120 via a flexible tube 202 at the intake opening 206 thereby creating a filtered air inner environment 205 from the positive pressure of filtered air 125 flowing through the helmet base opening 502. Certain embodiments envision the clear rigid helmet 500 resting on the person's shoulders 102 or on the top of their head 100, for example.

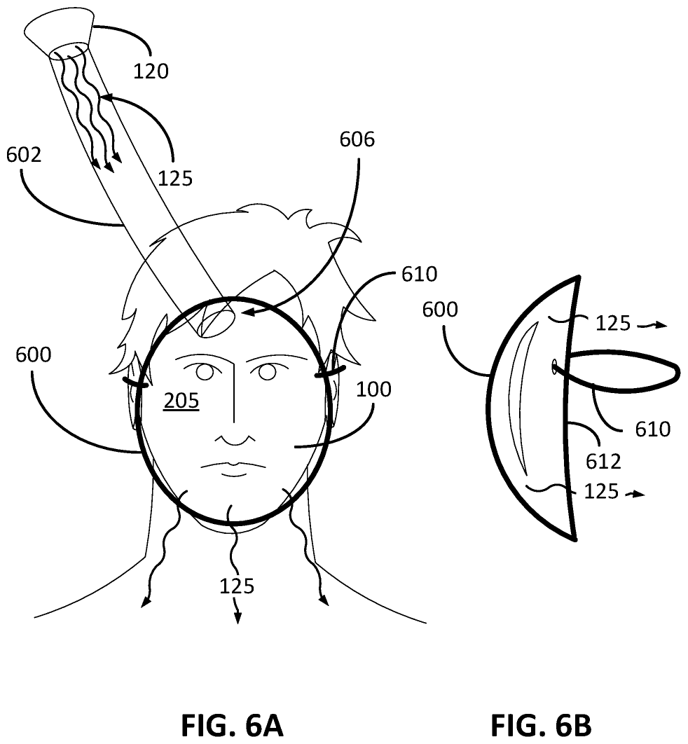

FIGS. 6A and 6B illustratively depict simple line drawings of a facemask embodiment consistent with embodiments of the present invention. The facemask embodiment 600 is a clear plastic facemask that covers a substantial portion of a passenger's face 105, as shown. As shown by the front view of FIG. 6A, the facemask 600 is connected to a flexible tube 602 at one end, the flexible tube 602 connected to the air vent 120 at the other end. Some embodiments envision the facemask 600 as being a unitary rigid clear mask that is retained on the passengers face 105 by way of an elastic strap 610. Again, filtered air 125 flowing from the air vent 120 creates filtered positive pressure air thereby creating a filtered air environment 205 that is continuously flushing over the passenger's eyes 110, nose 108 and mouth 106. FIG. 6B depicts a side view of the facemask embodiment whereby pressurized filtered air 125 can flow out along the open perimeter 612 of the facemask 600.

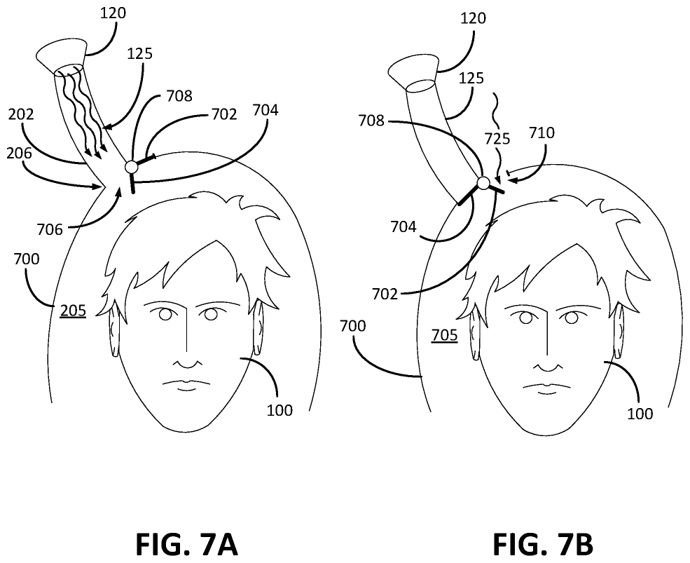

FIGS. 7A and 7B illustratively depict a simple line drawing of a valve system used with a positive pressure filtered air environment consistent with embodiments of the present invention. As shown in FIG. 7A, as positive pressure from the filtered air 125 flows from the air vent 120 through the flexible tube 202 a spring-loaded valve 704 embodiment is forced open thereby receiving the filtered pressurized air 125 via the intake opening/aperture 206. When the valve 704 is open to the pressurized filtered air 125, an ambient environment gate 702 closes an ambient environment opening/aperture 710. In this way, positive pressure from the filtered air can maintain a substantially filtered air environment 205 inside of the head covering 700. If the positive pressure from the air vent 102 stops, i.e., the year vent shuts off, than the spring-loaded valve opens the ambient environment gate 702 permitting ambient air 725 to flow into the head covering 702, FIG. 7B. This is a failsafe system in case the air vent 120 stops forcing filtered air 125 into the head covering 700.

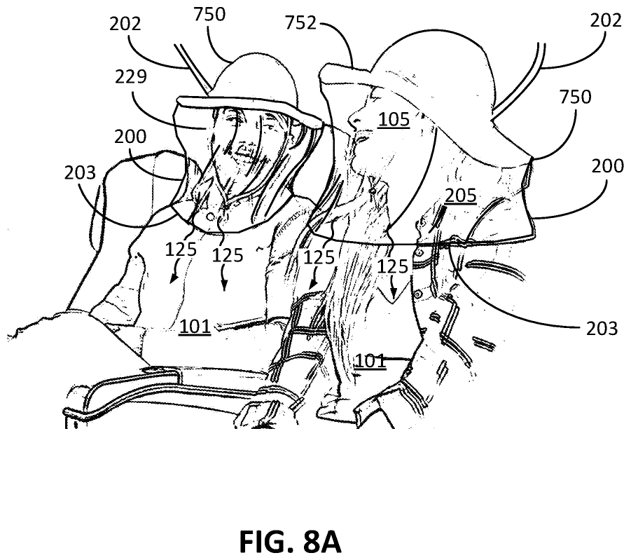

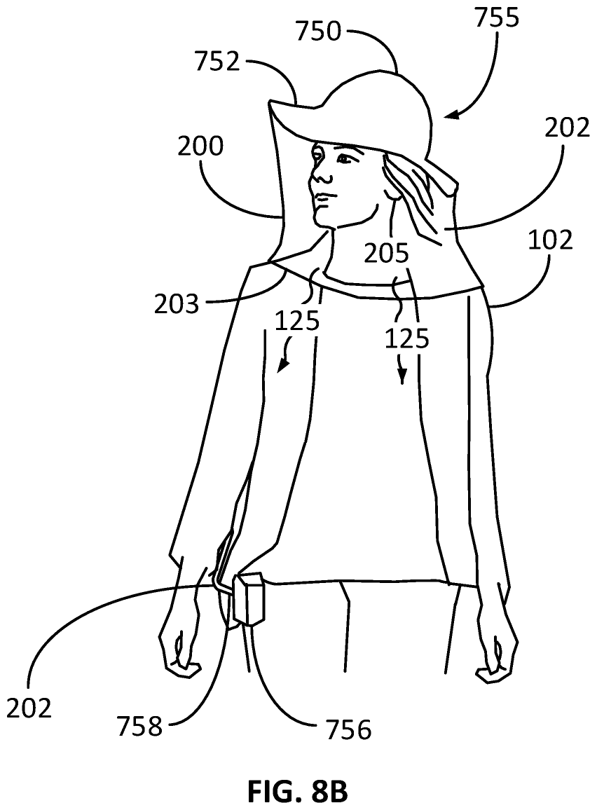

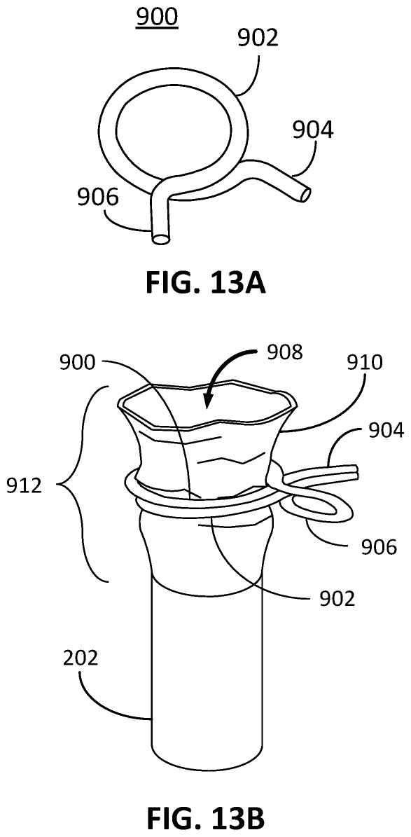

FIG. 8A it is a lined drawing illustration of two passengers 101 sitting on an airplane with the hood consistent with embodiments of the present invention. As shown here, the hood 200 is tented outward with some distance away from the passenger's face 105 by the rim 752 of the hat 750. Pressurized air is supplied from the air vent 120 through the inlet tube 202 and into the hood 200. Some examples of a flexible inlet tube 202 includes an expandable flex tube that can be shortened or lengthened to adjust to the different geometries of the passenger and air vent location with an additional benefit of flexibly moving with the passenger 101. Other embodiments envision at least one swivel connector attached to the tube for ease of mobility. Certain embodiments further envision a universal connector configured to connect to a plurality of different sized air vents 120, discussed in conjunction with FIGS. 13A and 13B. As shown, the passengers 101 are having a conversation through the thin, clear plastic hoods 200 while filtered air 125 constantly flows through the exit hood opening also referred to herein as an exit rim 203. In this embodiment, the hat comprises a strap 229 that can be cinched under the passengers chin 112 to hold or otherwise retain the hat 750 on the passenger's head 100.

FIG. 8B is a line drawing illustration of a woman wearing the hood and hat combination 755 in an environment other than the airplane consistent with embodiments of the present invention. Certain embodiments envision that the hood and hat combination 755 being used not only on an airplane but elsewhere with the assistance of a portable (battery-powered) filtered air handling system 756, also referred to as simply “filter pump” 756. In the present embodiment, a woman is shopping with the hat and hood combination 755 while protected by a filtered air 125 environment 205 within the hood 200. The filtered air environment 205 is created by pressurized air provided by the filter pump 756, which is transported to the hat and hood combination 755 via the flexible tube 202. As with the airplane, the filtered air 125 flows through the hood 200 and out through the hood opening 203 along the woman shoulders 102. Certain embodiments envision a universal connector 758 that can connect to both the airplane air vents 120 and a filter pump exit port/vent (not shown) extending from the filter pump 756. Accordingly, a person 101 can exit their car at the airport with their hood and hat combination 755, walk through the airport to their gate and board they airplane, all the while protected with the hood 200 infused with filtered air 125. Once on the plane, the passenger 101 can simply unplug their flexible tube 202 from their filter pump 756 and attach the flexible tube to the airplane air vent 120 above their seat. When disembarking the airplane, the passenger 101 can detach the flexible tube 202 from the airplane air vent 120 and reattach the flexible tube 202 to their filter pump 756. Obviously, there can be an on/off switch on the mobile battery-powered filter pump 756. Certain embodiments envision the filter pump 756 pumping air into the hood 200 via a HEPA filter media system, which is rated for over 99.9% filtration of 0.3 μm and larger particles. Other filtration media are envisioned either higher or lower filtration rating than a HEPA filter without departing from the scope and spirit of the present invention. Certain other embodiments envision a filter media, such as a HEPA filter or ULPA filter, in-line with the flexible tube 202 whereby the battery-powered pump does not have to include a filter.

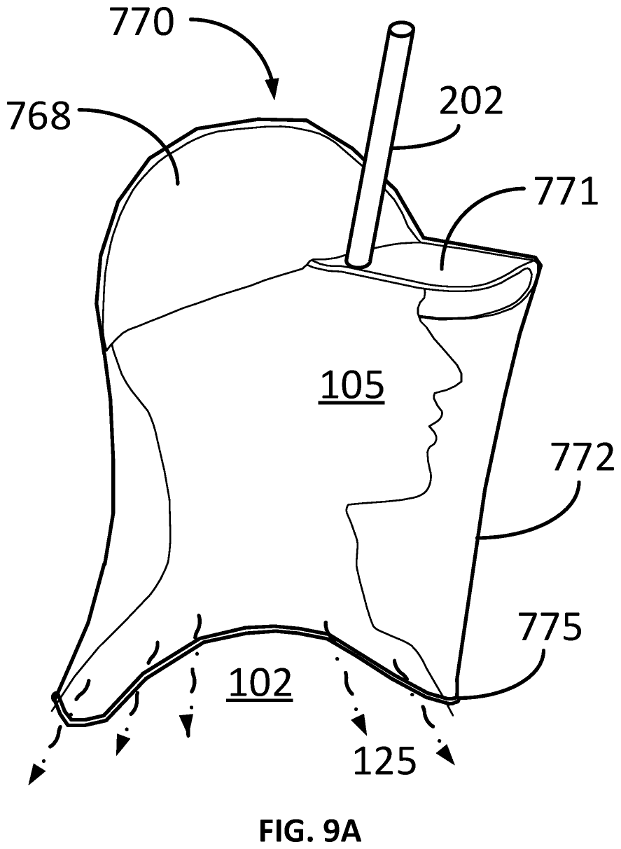

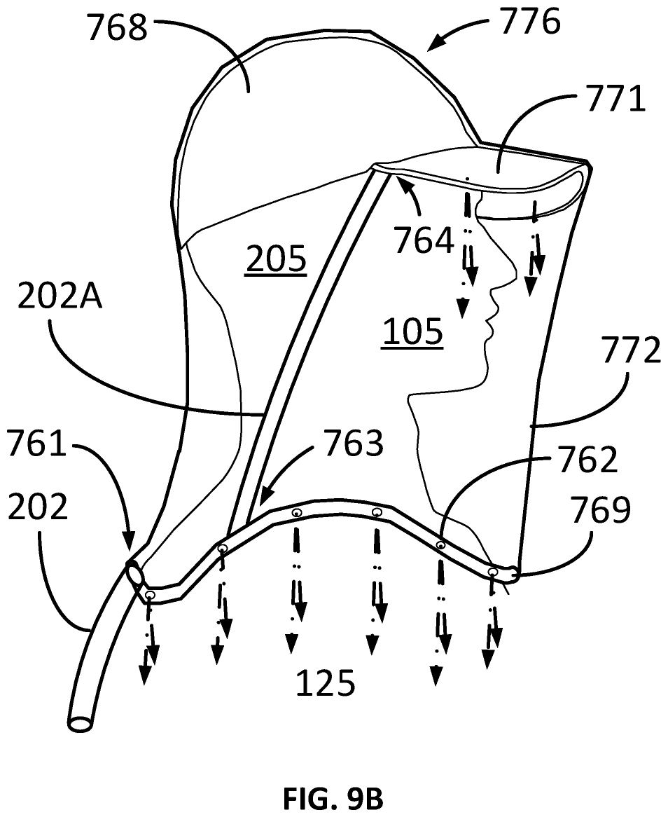

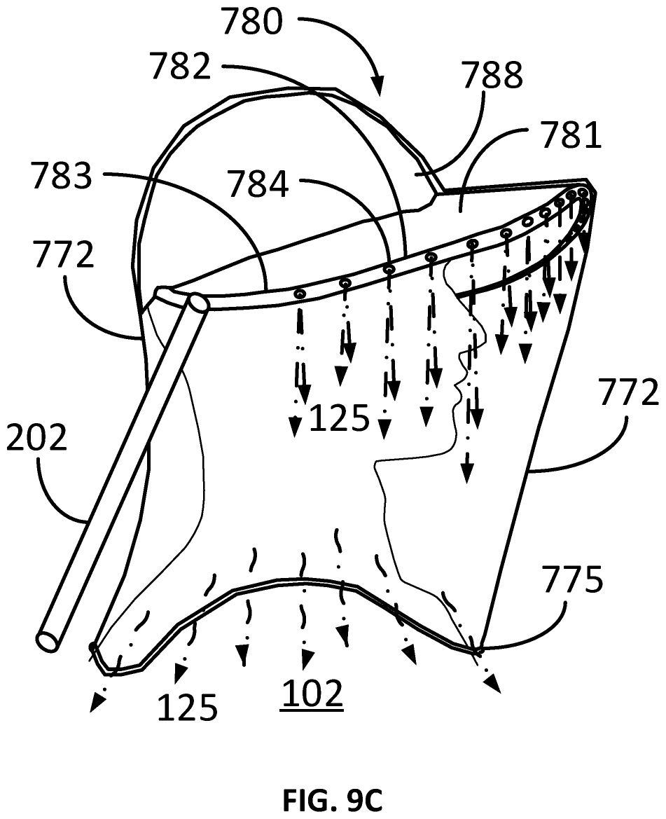

FIG. 9A illustratively depicts a line drawing of a profile of a human head wearing a hat and hood combination 770 consistent with embodiments of the present invention. As shown, the hood 772 essentially covers a baseball hat 768 and dangles from the baseball hat bill 771 thereby providing space between the person's face 105 and the hood 772. The hood 772 can be manufactured to conform to the baseball hat 768 so that it fits in place. Some embodiments envision an elastic band or some other retaining band fitting around the base of the baseball hat 768 on the outside of the hood 772. In the present embodiment, the hood 772 terminates along a bottom semi-rigid hood exit border 775, such as a wire or semi-rigid polymer opening, which conforms to the wearer's shoulders 102 and sternum. The semi-rigid hood exit border, or exit border, 775 can be weighted to pull the hood 772 in a more taught arrangement to further avoid obstructing the face 105 or having the hood 772 touching the face 105. Filtered air 125 can be pressurized to flow through the flexible tube 202 and out through the semi-rigid hood exit border 775. Certain embodiments envision a small gap between the semi-rigid hood exit border 775 and the wearer's shoulders 102 and sternum in order to let the filtered air 125 flow out. In other words, there is an intentional space between the wire-rimmed and the wearer's body. Moreover, in this way if there is any kind of failure of the flow through the flexible tube 202 air (albeit unfiltered) can still seep in through the opening at the semi-rigid hood exit border 775 so that a person is never deprived of oxygen. Other embodiments envision that the hood is made from a thin plastic bag of less than 1.0 μm thickness, which can be easily torn away by the wearer in case of a failure.

FIG. 9B illustratively shows an alternative embodiment of a hat and hood combination 776 consistent with embodiments of the present invention. The only difference of this hat and hood combination 776 with that of FIG. 9A, is that the bottom opening/exit rim 769 is a perforated hollow tube that is attached directly 761 to the flexible air intake tube 202. In addition to filtered air 125 gently pouring down across the wearer's face 105, filtered air 125 additionally flows out along the bottom of the hood 772 to further discourage the movement of germs (bacteria, viruses, mold, or other contaminants) into the inner hood environment 205. In other words, the perforations 762 prevent any dead space along the opening 203 thereby preventing the likelihood of germs from going into the inner hood environment 205. Certain other embodiments envision a flexible tube 202A that ports filtered air to the hat bill 771 providing filtered air to flow over the person's face 105. In the present embodiment, the flexible tube 202A is connected to the perforated bottom opening rim 769 at connection point/location 763 and connecting to the hat bill 771 at the bill connection location 764.

FIG. 9C is a line drawing of a person wearing an optional hat embodiment consistent with embodiments of the present invention. This hat and hood combination embodiment 780 generally comprises a hat 788 with a larger bill 781 stretching along a significant portion of the opening of hat 788. In this embodiment, the bill 781 can further possess a perforated tube 783 attach to the brim 782 with the plurality of perforations through which filtered air 125 can pour over the person's face 105. It is envisioned that air pouring through perforations 784 in the perforated tube 783 can flow over the person's face 105 away from their eyes 110. The filtered air 125 is envisioned to have enough pressure to flow positively out of the bottom opening 103 along the semi-rigid hood exit border 775. It should be appreciated that the embodiments presented in combination with FIGS. 9A-9C, as well as all other embodiments presented herein, can be mixed and matched without departing from the scope and spirit of the present invention.

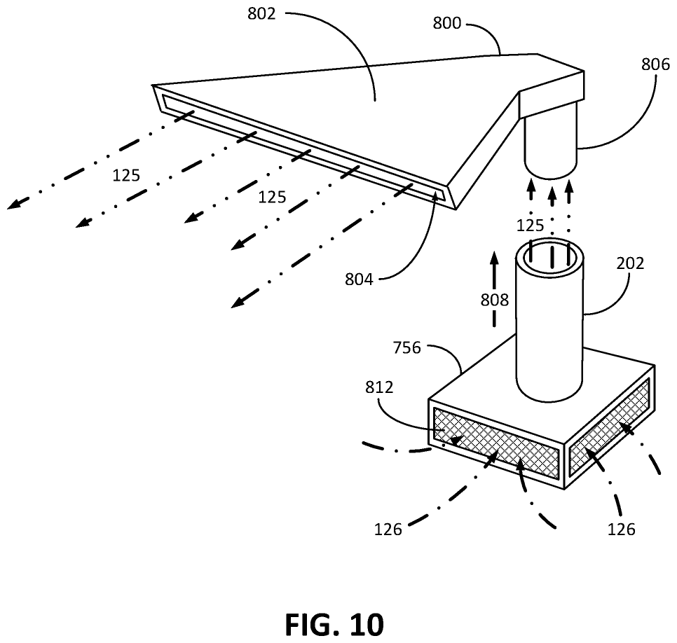

FIG. 10 illustratively depicts yet another embodiment of an air delivery system consistent with embodiments of the present invention. A portable (battery-powered) filtered air handling system 756 embodiment can include any number of “on the market” filtered pumps that can provide enough pressure to positively flow filtered air into a hat and hood arrangement. As shown, unfiltered/ambient air 126 is sucked in through the filter media 812, which in certain embodiments is a HEPA filter or optionally an ULPA filter, pushing filtered air 125 into the filtered air distribution unit 800. A shortened version of the flexible tube 202 is intended to be connected to the filtered air distribution unit 800 via the connection port 806 in the direction of the arrow 808. When the filtered air distribution unit 800 is connected to the filter pump 756 via the flexible tube 202, air pump from the filter pump 756 is distributed through the hollow unit/housing 800 and out through an outlet slot 804. In the present embodiment, the filtered air distribution unit 800 is fanned out as shown and further comprises a flat top surface 802 that can be attached to the underside of a hat brim, such as by adhesive or bolts just to name a couple of fastening embodiments that would be known and understood by those skilled in the art. In the present embodiment, the outlet slot 804 is tilted downward to help point the flow over a person's face. One or more of the filtered air distribution units 800 can be interconnected and attach to various locations on the bottom (underneath side) of a hat brim.

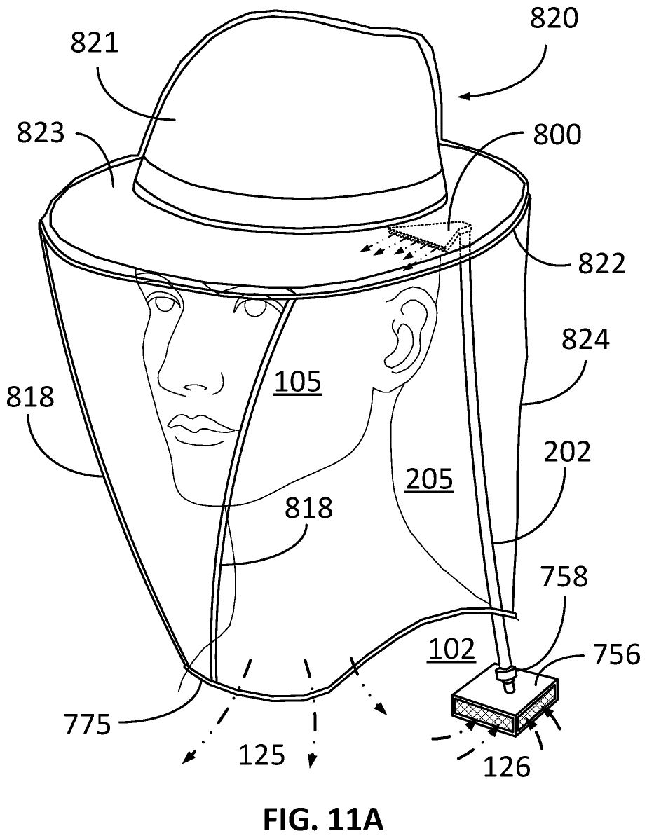

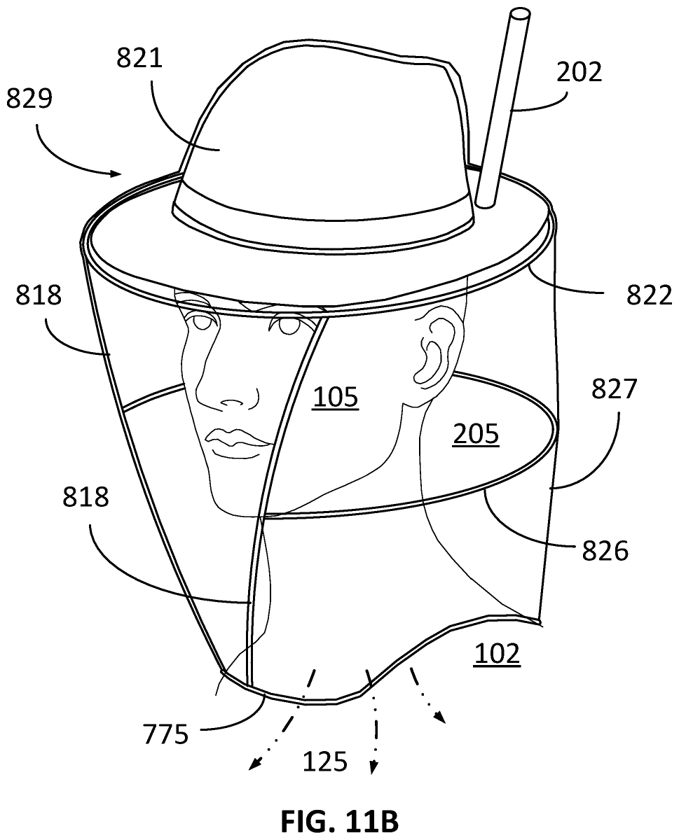

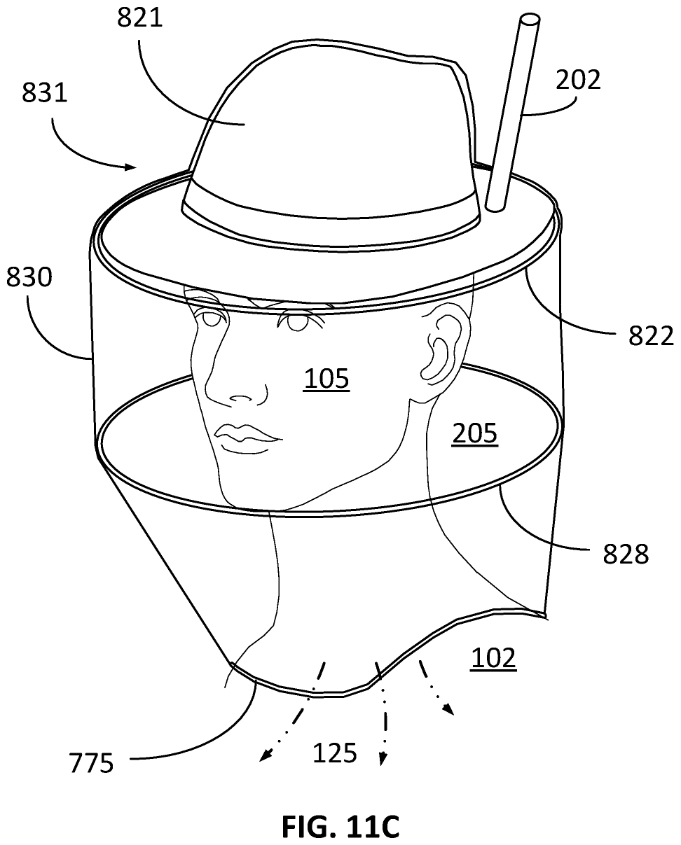

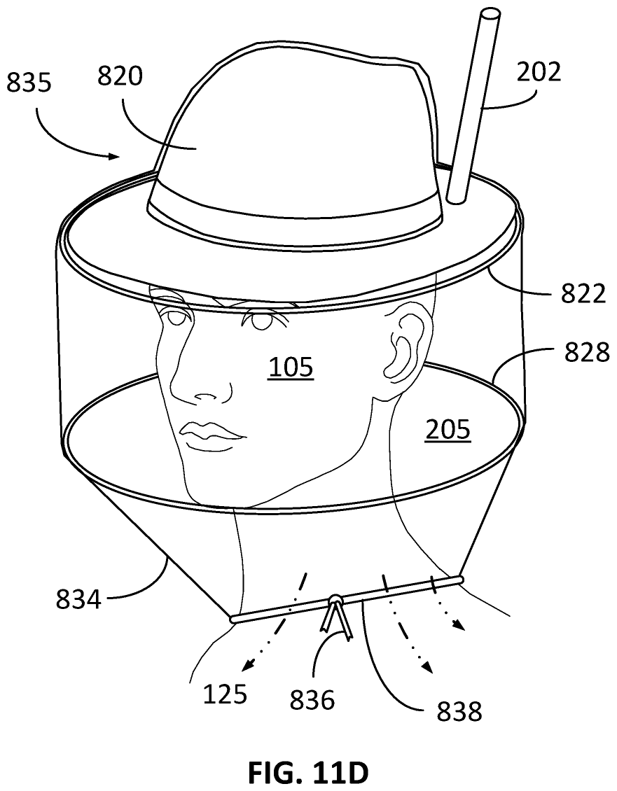

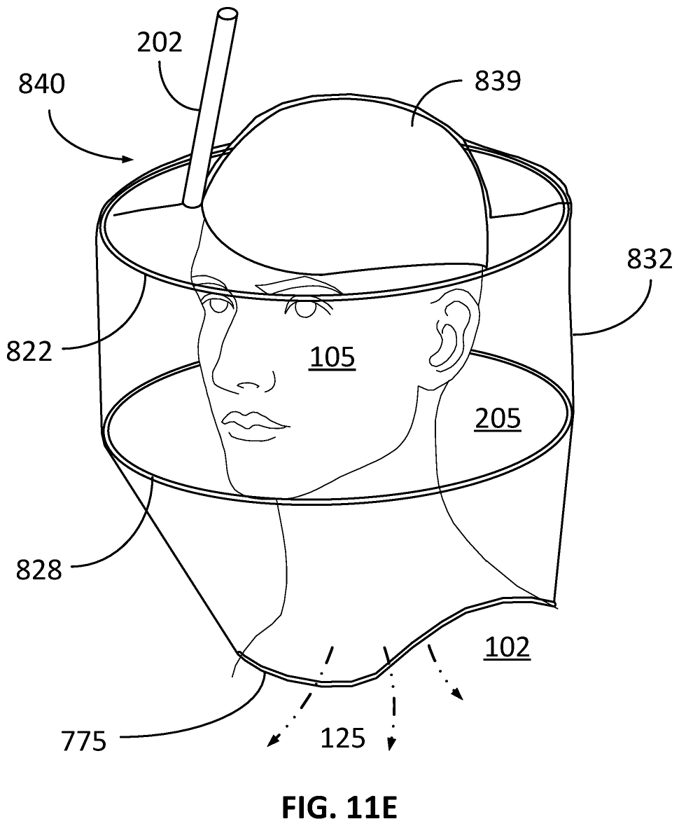

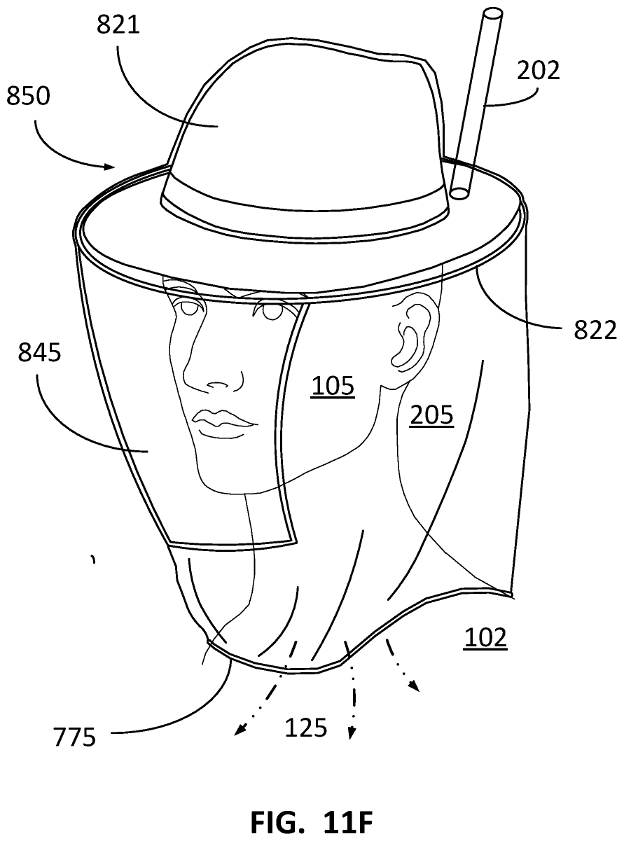

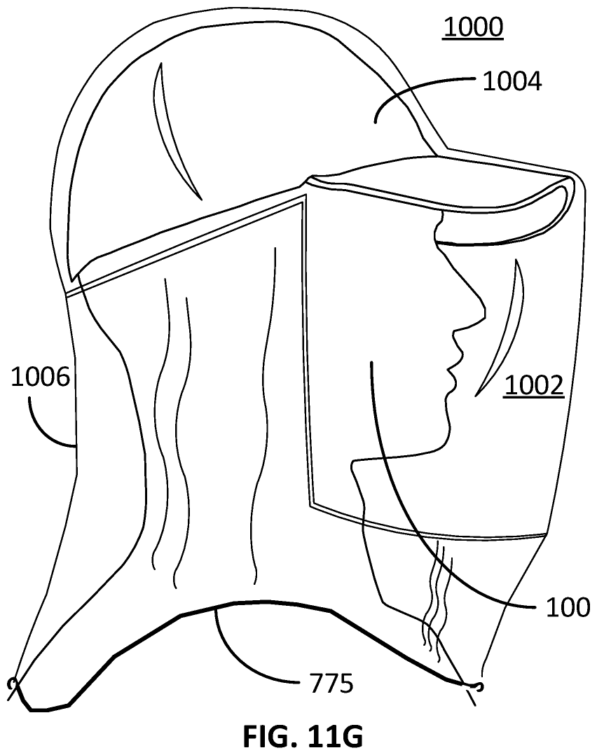

FIG. 11A illustratively depicts an optional hat and hood combination 820 consistent with embodiments of the present invention. The hood and hat combination 820 includes a full brimmed hat 821, at least one filtered air distribution unit 800 attached to the underside of the brim 823, and a front-paneled hood 824. More specifically, the hood 824 covers the hat 821 with a semi-rigid hoop/ring 822 along the edge of the brim 823 and a pair of semi-rigid vertical supports 818 that extend from the semi-rigid hoop 822 to the semi-rigid hood exit border 775. The vertical supports 818 provide some structure distance of the thin plastic hood 824 from a person's face 105. In the present embodiment, the vertical supports 818 are positioned in a “V-Shape”, but could just as easily be arranged along different paths, such as parallel, oval, circular, etc. Certain embodiments envision the semi-rigid vertical supports 818 made out of a polymer strip, metal wire, or some other material that allows for some bending movement. Attached the underside of the brim 823 is a filtered air distribution unit 800 depicting filtered air 125 exiting the outlet slot 804. The filtered air distribution unit 800 is connected to a filter pump 756 by way of a universal connector 758. Certain embodiments envision the universal connector 750 being configured to attach, or clamp to a filter pump port nozzle (not shown) and an airplane air vent 120. Some embodiments envision a region near or on the exit border 775 comprising Velcro or other material that sticks to clothing with low adhesive force to easily stick on and pull off. In this embodiment, there needs to be at least a small gap between a person's shoulders 102 and sternum and the exit border 775 for the filtered air 125 to positively flow from the hood to maintain a reasonably pure inner hood environment 205.

FIG. 11B is a line drawing depicting another embodiment of a hat and hood combination consistent with embodiments of the present invention. The hat and hood combination embodiment 829 generally comprises the features described in FIG. 11A, however a semicircular or semi-elliptical semi-rigid hoop 826 is attached to the two semi-rigid vertical supports 818 to provide more of a tent-like arrangement with the hood 827. The semi-rigid hoop 826 can also be made out of wire, a pliable but semi-rigid polymer or some other material within the scope and spirit of the present invention.

FIG. 11C is a line drawing showing yet another embodiment of a hat and hood combination consistent with embodiments of the present invention. The hat and hood combination embodiment 831 generally comprises a full brimmed hat 821 with a hoop around the brim 822 and a second hoop 828 in positioned between (and including) a person's nose 108 and neck 104. The second hoop 828 provides a tenting effect of the hood 832 improve reducing contact of the hood 830 with the person's face 105.

FIG. 11D is a line drawing showing a different embodiment of a hat and hood combination consistent with embodiments of the present invention. The hat and hood combination embodiment 835 is similar to the hat and hood combination 831 of FIG. 11C, however instead of a semi-rigid hood exit border 775, there is a drawstring 838 along the bottom of the hood 834. Certain embodiments envision the drawstring 838 only being able to be cinched to loosely fit around a person's neck 104, such as for example ½ an inch to 1 inch of space between the person's neck and the drawstring 838.

FIG. 11E illustratively depicts a line drawing of yet a different embodiment of a hat and hood combination consistent with embodiments of the present invention. The hat and hood combination embodiment 840 is similar to the hat and hood combination 831 of FIG. 11C, however instead of a full-brimmed hat 821, there is essentially a skullcap 839 with just and upper wire hoop 822 that creates a tenting effect together with the second hoop 828.

FIG. 11F is a line drawing that illustratively depicts a person wearing yet a different embodiment of a hat and hood combination 850 consistent with embodiments of the present invention. The hat and hood combination embodiment 850 is similar to the hat and hood combination 831 of FIG. 11C, however instead of a wire armature, a clear plastic face shield 845 is bonded to the plastic hood 200.

FIG. 11G is a line drawing that illustratively depicts a person wearing yet another embodiment of a hat hood combination 1000 consistent with embodiments of the present invention. In this embodiment, the person 100 is wearing a hood that has a single molded hat shaped piece of plastic 1004 and face shield 1002 bonded to a flexible plastic hood portion 1006. The exit rim 775 is shown in this particular embodiment, however other configurations for the exit opening can be employed without departing from the scope and spirit of the present invention.

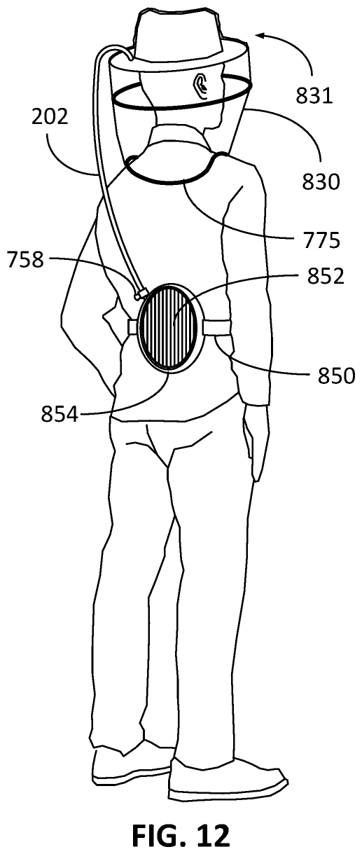

FIG. 12 is a line drawing of a back view of a standing person wearing a hat and hood combination with a filter system consistent with embodiments of the present invention. The hat and hood combination 831 shows the hat rim 823 encircling the back of the person's head 100 with the exit border 775 resting on the person's shoulders and back. When powered, the filter pump 854 pulls in unfiltered/ambient air through a filter media 852, which could be a HEPA filter or the like, pumping filtered air through the flexible hose/tube 202 and into the hood 830. In the present embodiment, the filter pump 854 is attached to the person's waist via a belt 850. The universal connector 758 can be attached and detached from a nozzle (not shown) that extends from the filter pump 854. Though in the present embodiment the pump is attached to a belt on the person's waist, some embodiments envision the pump being located just about anywhere including near or on a person's head 100.

FIGS. 13A and 13B show an example of a universal connector system consistent with embodiments of the present invention. FIG. 13A is a line drawing of a spring-loaded ring clamp 900 that can be used to universally clamp a flexible tube 202 on any number of airplane air vent nozzles 120 and a portable filter pump nozzle, so long as they are within a ¼ to ½ inch difference in outer diameter. Other embodiments are not limited to these diameter differences. As shown, a spring-loaded ring clamp 900 has a spring-loaded ring 902 wherein the ring 902 becomes bigger when the two finger tabs 904 and 906 are squeezed together and become smaller when the two finger tabs 904 and 906 are released.

FIG. 13B illustratively depicts one embodiment of the attachment end of the flexible tube 202. In this embodiment, the flexible tube 202 comprises a thin flexible rubberized top region 912 that loosely fits over a nozzle. Whether the nozzle is tapered or a different shape the rubberized top region 912 fits over the nozzle and the ring clamp 900 clamps around the nozzle. The rubberized top region 912 is envision to be a high friction, “sticky” rubber that when clamped around the nozzle will be difficult to pull off without squeezing the two finger tabs 904 and 906 together to open up the ring 902.

Certain embodiments envision perforations or at least one flap in the front of the hood over the mouth 106 and nose 108 as a failsafe from the hood blocking the mouth 106 or nostrils 108. Certain other embodiments additionally envision providing airflow either with a perforated tube or directed at the nose and mouth area of the hood always blowing filtered air out of the hood from the nose and mouth location if perforations a located there. Some embodiments of the present invention envision the plastic could being disposable and between 0.5 μm and one 1 μm in thickness making it easy to tear off if a problem exists. Other embodiments envision the hood being a disposable thin plastic hood that is simply discarded after using for several hours.

With the present description in mind, below are some examples of certain embodiments illustratively complementing some of the methods and apparatus embodiments to aid the reader. The elements called out below are examples provided to assist in the understanding of the present invention and should not be considered limiting.

In that light, as depicted primarily in FIG. 2, but also in the other figures, certain embodiment contemplate a protective airplane hood arrangement comprising a hood 200 defining a hood interior 205 having an upper half 230 and a lower half 232 and further defining a hood crown 212 that is configured to interface a human head apex 214. The hood 200 is sized to cover a person's head 100 and terminating in a hood exit rim/opening 203 that is between a person's chin 112 and their shoulders 102. A tube 202 extends between a proximal end 218 and a distal end 216 wherein the distal end 216 comprises an overhead airplane ventilation nozzle coupling (coupling) 910. The proximal end 218 in communication with the hood interior 205 wherein the hood interior 205 in communication with the coupling 910. The coupling 910 is configured to connect to an overhead airplane ventilation nozzle 120. The tube 202 is configured to channel air 125 from the overhead airplane ventilation nozzle 120 and into the hood interior 205 within 4 inches vertically 222 (in the vertical direction shown in FIG. 2) from the hood crown 212.

The protective airplane hood arrangement further imagining the hood exit rim 203 not covered by hood material.

The protective airplane hood arrangement further contemplating the hood 200 being a unitary piece of clear plastic. This can further be wherein the hood 200 has a thickness that is less than 2 μm.

The protective airplane hood arrangement further envisioning the proximal end 218 of the tube 202 being attached to the hood 200 via an aperture 206 in the hood 200. This can further be wherein the aperture 206 is located within 3.5 inches from the crown 212 in a vertical direction 222.

The protective airplane hood arrangement further pondering wherein the channeled air 125 that is inside of the hood 200 exits only from the hood exit rim 203 when the coupling 910 is connected to the overhead airplane ventilation nozzle 120 and the channeled air 125 is provided by the overhead airplane ventilation nozzle 120.

The protective airplane hood arrangement further considering the hood exit rim 203 being configured to reside between a person's chin 112 and a person shoulder 102 when worn.

The protective airplane hood arrangement further imagining the hood 200 comprising an armature 402 the provides stiffness to the hood, such as a wire frame, for example.

The protective airplane hood arrangement further envisioning the hood 200 comprising a clear plastic face shield 1002.

The protective airplane hood arrangement further comprising a safety valve 710 that is configured to permit outside air 725 from the outside environment 210 to enter inside of the hood 200 only when the overhead airplane ventilation nozzle 120 does not provide channeled air 125 to the hood 200.

The protective airplane hood arrangement further comprising a hat structure 788 that cooperates with the hood 200. This can further be wherein the hat structure 788 is configured to dispense the channeled air 125, which in some embodiments is via the bill 781 on the hat 788.

The protective airplane hood arrangement further contemplating the channeled air 125 flowing over a face 105 of the person 100.

Yet another embodiment of the present invention contemplates a hood arrangement comprising a hood 200 defining a hood interior 205, a hood crown 212 and a hood exit rim 203. The hood exit rim 203 is configured to pull over a person's head 100 until the hood 200 cover's the person's head 100. A hollow tube 202 extends from the hood 200 and attaches to an overhead airplane ventilation nozzle 120 at a distal tube end 216 of the tube 202 via an overhead airplane ventilation nozzle coupling (coupling) 910. Pressurized air 125 that is dispensed from the overhead airplane ventilation nozzle 120 flows from a proximal end 218 of the hollow tube 202 towards and through the hood exit rim 203.

The hood arrangement further contemplating the hood exit rim 203 being configured to reside between a person's chin 112 and shoulder 102.

The hood arrangement further envisioning wherein the coupling 910 includes a clamp 904 that clamps around the overhead airplane ventilation nozzle 120.

The hood arrangement further pondering wherein the hood 200 is transparent over at least a face portion 1002 of the hood 200.

Still other certain embodiments of the present invention contemplate an airplane filtered air hood system comprising a hood 200 configured to cover a person's head 100. The hood system further including a hollow tube 202 that extends from the hood 200 to be connected to an overhead airplane ventilation nozzle 120 via an overhead airplane ventilation nozzle coupling 910. A hood interior 205 of the hood 200 is in communication with the overhead airplane ventilation nozzle 120 via the hollow tube 202. A hood exit rim 203 receives channeled filtered air 125 from inside of the hood 200 wherein the filtered air 125 is exclusively provided by the overhead airplane ventilation nozzle 120 via the hollow tube 202.

The above sample embodiments should not be considered limiting to the scope of the invention whatsoever because many more embodiments and variations of embodiments are easily conceived within the teachings, scope and spirit of the instant specification.

It is to be understood that even though numerous characteristics and advantages of various embodiments of the present invention have been set forth in the foregoing description, together with the details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, though the embodiments teach and inexpensive clear plastic hood, helmet and facemask with flexible plastic tube 202, other configurations could equally be used while still maintaining substantially the same functionality without departing from the scope and spirit of the present invention. Other embodiments envision the system equally capable of being used with a standalone air filtration system that can be battery-powered and carried with the user, such as in a backpack or on a belt, just to name several examples without departing from the overall concept of the present invention. Certain other embodiments envision many attachment schemes to connect the flexible tube 202 to the air vent 120, such as clamps, expandable material on the end of the tube 202, adhesive, clips, etc. that would be known to those skilled in the art. Also, though the hoods 200 and 300 go to the shoulders and to the neck, respectively, other embodiments envision going lower than the shoulders without departing from the present invention. Though most of the embodiments disclosed herein are directed to a hood that is essentially a bag with essentially a single opening to pull over a person's head 100, certain other embodiments envision a tubular hood snapping around a hat such as to a brim, the sides, etc. without departing from the scope and spirit of the present invention. Further, the terms “one” is synonymous with “a”, which may be a first of a plurality. It should further be appreciated that any one or more of the elements depicted in one or more embodiments described herein can be combined with any one or more other elements described in conjunction with one or more other embodiments described herein.

It will be clear that the present invention is well adapted to attain the ends and advantages mentioned as well as those inherent therein. While presently preferred embodiments have been described for purposes of this disclosure, numerous changes may be made which readily suggest themselves to those skilled in the art and which are encompassed in the spirit of the invention disclosed.

What is claimed is:

1. A protective airplane hood arrangement comprising:
a hood defining a hood interior having an upper half and a lower half, the hood sized and configured to cover a person's head, the hood defining a hood crown configured to interface a human head apex that extends to a hood exit rim,
a tube 202 extending between a proximal end and a distal end, the distal end comprising an overhead airplane ventilation nozzle coupling (coupling),
the proximal end in communication with the hood interior, the hood interior in communication with the coupling,
the coupling configured to connect to an overhead airplane ventilation nozzle,
the tube 202 configured to channel air from the overhead airplane ventilation nozzle into the hood interior within 4 inches vertically from the hood crown.

2. The protective airplane hood arrangement of claim 1 wherein the hood exit rim is not covered by hood material.

3. The protective airplane hood arrangement of claim 1 wherein the hood is a unitary piece of clear plastic.

4. The protective airplane hood arrangement of claim 3 wherein the hood has a thickness that is less than 2 μm.

5. The protective airplane hood arrangement of claim 1 wherein the proximal end is attached to the hood via an aperture in the hood.

6. The protective airplane hood arrangement of claim 5 wherein the aperture is located within 3.5 inches from the crown in a vertical direction.

7. The protective airplane hood arrangement of claim 1 wherein the channeled air that is inside of the hood exits only from the hood exit rim when the coupling is connected to the overhead airplane ventilation nozzle and the channeled air is provided by the overhead airplane ventilation nozzle.

8. The protective airplane hood arrangement of claim 1 wherein the hood exit rim is configured to be between a person's chin and a person shoulder.

9. The protective airplane hood arrangement of claim 1 wherein the hood comprises an armature.

10. The protective airplane hood arrangement of claim 1 wherein the hood comprises a clear plastic face shield.

11. The protective airplane hood arrangement of claim 1 further comprising a safety valve configured to permit outside air from the outside environment to enter inside of the hood only when the overhead airplane ventilation nozzle does not provide channeled air to the hood.

12. The protective airplane hood arrangement of claim 1 further comprising a hat structure that cooperates with the hood.

13. The protective airplane hood arrangement of claim 12 wherein the hat structure is configured to dispense the channeled air.

14. The protective airplane hood arrangement of claim 12 wherein the hat structure is configured to dispense the channeled air via a bill on the hat.

15. The protective airplane hood arrangement of claim 1 wherein the channeled air is directed to flow over a face of the person.

16. A hood arrangement comprising:
a hood defining a hood interior, a hood crown and a hood exit rim,
the hood exit rim is configured to pull over a person's head until the hood cover's the person's head,
a hollow tube extending from the hood and attached to an overhead airplane ventilation nozzle at a distal tube end via an overhead airplane ventilation nozzle coupling (coupling); and
pressurized air dispensed from the overhead airplane ventilation nozzle is arranged to flow from a proximal end of the hollow tube towards and through the hood exit rim.

17. The hood arrangement of claim 16 wherein the hood exit rim configured to reside between a person's chin and shoulder.

18. The hood arrangement of claim 16 wherein the coupling includes a clamp configured to clamp around the overhead airplane ventilation nozzle.

19. The hood arrangement of claim 16 wherein the hood is transparent over at least a face portion of the hood.

20. An airplane filtered air hood system comprising:
a hood configured to cover a person's head;
a hollow tube extending from the hood and connected to an overhead airplane ventilation nozzle via an overhead airplane ventilation nozzle coupling (coupling);
a hood interior of the hood in communication with the overhead airplane ventilation nozzle via the hollow tube; and
a hood exit rim that receives channeled filtered air from inside of the hood, the filtered air exclusively provided by the overhead airplane ventilation nozzle via the hollow tube.
